(19) United States
(12) Patent Application Publication
(10) Pub. No.: US 2014/0089862 A1
(43) Pub. Date: Mar. 27, 2014

(54) DESTINATION ROUTING IN A VIRTUAL WORLD

(71) Applicants: Ryan C. Jones, Kirkland, WA (US); Jonathan P. Knoles, Woodinville, WA (US); Ralph M. Fulton, Royal Leamington Spa (GB); Karl J. Hammarling, Daventry (GB); William T. Stones, Warwick (GB); Denis Mouraux, Little Tew (GB)

(72) Inventors: Ryan C. Jones, Kirkland, WA (US); Jonathan P. Knoles, Woodinville, WA (US); Ralph M. Fulton, Royal Leamington Spa (GB); Karl J. Hammarling, Daventry (GB); William T. Stones, Warwick (GB); Denis Mouraux, Little Tew (GB)

(73) Assignee: MICROSOFT CORPORATION, Redmond, WA (US)

(21) Appl. No.: 13/624,497

(22) Filed: Sep. 21, 2012

(51) Int. Cl. G06F 3/048

(52) U.S. Cl. 715/851

(57) ABSTRACT

A user input requesting a route that satisfies particular criteria (e.g., a route to one or more destinations) in a virtual world is received. A route from the current location of the user in the virtual world that satisfies the criteria is determined, and an indication of this route is displayed to the user. The indication of the route is displayed in a gameplay mode in which the user can immerse himself or herself in the virtual world. The indication of the route can be a multi-purpose indication, such as additionally indicating where it is recommended that the user accelerate or brake in a racing game. The user input can be received while the user is in the gameplay mode, allowing the user to remain immersed in the virtual world while requesting the route.

### BACKGROUND

As computing technology has advanced, games and virtual worlds that users can explore have become increasingly complex. Given this complexity, it can be difficult for users to determine the route to a desired destination within the game or virtual world. Some games provide map screens that allow a user to switch away from the virtual world view, plan and memorize a route to a desired destination while viewing the map screen, and then return to gameplay in the virtual world. However, such techniques for identifying routes are cumbersome on the user and detract from the immersion of the user in the virtual world.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a user input requesting a route that satisfies user input criteria in a virtual world is received. The route from the current location of the user in the virtual world that satisfies the user input criteria is obtained. An indication of this route is displayed in the virtual world in a gameplay mode in which the user interacts with the virtual world.

In accordance with one or more aspects, independent of a map mode in which a map of a virtual world is displayed, a user request for a route that satisfies user input criteria in the virtual world is received. The route that satisfies the user input criteria is obtained, and an indication of the route is displayed independent of the map mode.

### BRIEF DESCRIPTION OF THE DRAWINGS

The same numbers are used throughout the drawings to reference like features.

FIG. 1 illustrates an example virtual world system implementing the destination routing in a virtual world in accordance with one or more embodiments.

FIG. 2 illustrates an example gaming device and display in additional detail in accordance with one or more embodiments.

FIG. 3 illustrates an example of a gameplay mode for a virtual world in accordance with one or more embodiments.

FIG. 4 illustrates an example of a map mode for a virtual world in accordance with one or more embodiments.

FIG. 5 illustrates another example of a gameplay mode for a virtual world in accordance with one or more embodiments.

FIG. 6 illustrates an example of a gameplay mode with a route indication in accordance with one or more embodiments.

FIG. 7 illustrates another example of a gameplay mode with a route indication in accordance with one or more embodiments.

FIG. 8 illustrates another example of a gameplay mode with a route indication in accordance with one or more embodiments.

FIG. 9 is a flowchart illustrating an example process for implementing the destination routing in a virtual world in accordance with one or more embodiments.

FIG. 10 illustrates an example system that includes an example computing device that is representative of one or more systems and/or devices that may implement the various techniques described herein.

### DETAILED DESCRIPTION

Destination routing in a virtual world is discussed herein. A user inputs a request for a route that satisfies particular criteria (e.g., a route to one or more destinations or a route to achieve a goal) in a virtual world. A route from the current location of the user in the virtual world that satisfies the criteria is determined, and an indication of this route is displayed to the user. The indication of the route is displayed in a gameplay mode in which the user can immerse himself or herself in the virtual world (e.g., the indication can be a line on a road that the user is driving on in the virtual world). The user is able to input the request for the route while in the gameplay mode, allowing the user to remain immersed in the virtual world while inputting the request for the route.

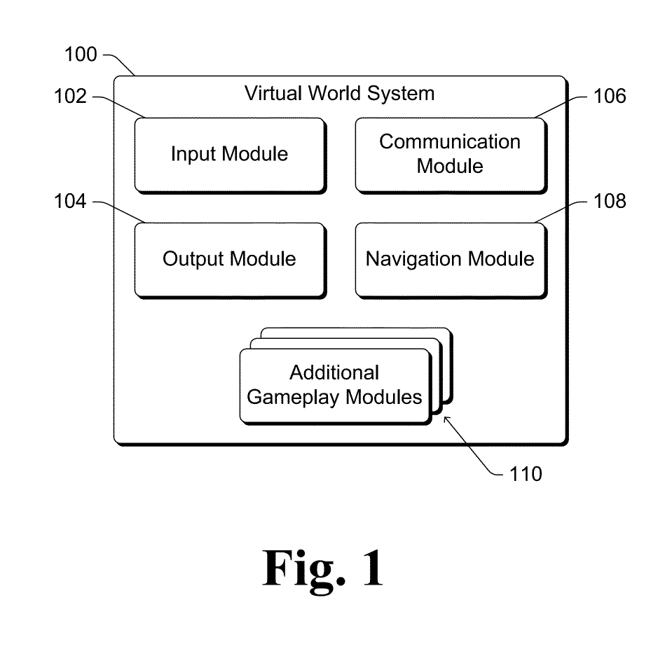

FIG. 1 illustrates an example virtual world system 100 implementing the destination routing in a virtual world in accordance with one or more embodiments. System 100 can be implemented by one or more of any of a variety of different types of devices, such as a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth. System 100 may be implemented by devices ranging from full resource devices with substantial memory and processor resources (e.g., personal computers, game consoles) to low-resource devices with limited memory and/or processing resources (e.g., traditional set-top boxes, hand-held game consoles).

Virtual world system 100 includes an input module 102, an output module 104, a communication module 106, a navigation module 108, and one or more additional gameplay modules 110. Each of modules 102-110 can be implemented in software, firmware, hardware, or combinations thereof. When implemented in software or firmware, a module includes one or more instructions that are executed by one or more processors or controllers of one or more devices implementing system 100. Although individual modules 102-110 are illustrated, it should be noted that the functionality of any module 102-110 can be implemented in multiple modules rather than a single module, and/or that at least some of the functionality of any two or more of modules 102-110 can be combined into a single module. Modules 102-110 can be part of the same program or application (e.g., a game), or alternatively part of two or more different programs or applications. For example, modules 102 and 106 can be implemented by an operating system of system 100, and modules 104, 108, and 110 can be implemented by a game program of system 100.

Input module 102 receives user inputs from a user of system 100. User inputs can be provided in a variety of different manners, such as by pressing one or more keys of a keypad or keyboard, pressing one or more keys of a controller (e.g., remote control device, mouse, trackpad, etc.), pressing a particular portion of a touchpad or touchscreen, making a particular gesture on a touchpad or touchscreen, and/or making a particular gesture on a controller (e.g., remote control device, mouse, trackpad, etc.), and so forth. User inputs can also be provided via other physical feedback input to system 100, such as tapping any portion of a device implementing system 100, an action that can be recognized by a motion detection component (such as shaking a device implementing system 100, rotating a device implementing system 100, etc.), and so forth. User inputs can also be provided in other manners, such as via voice or other audible inputs to a microphone, via motions of hands or other body parts observed by an image capture device, and so forth.

Output module 104 generates, manages, and/or outputs a user interface for display on a screen. This user interface displays various information generated by one or more other modules (e.g., navigation module 108, additional gameplay modules 110, etc.), and can be based at least in part on user inputs received by input module 102. Output module 104 can output the user interface to a screen that is a display component of a device implementing system 100 and/or output module 104 can generate one or more signals that are output to other display devices that include one or more screens.

Communication module 106 manages receiving of communications from and/or sending of communications to various devices. Communication module 106 can communicate with other devices (e.g., other than those implementing system 100) using various wired and/or wireless connections, such as one or more networks (e.g., the Internet, a local area network, a personal area network, etc.), a wired connection (e.g., a universal serial bus (USB) connection), an infrared or wireless USB connection, and so forth. Various different communications can be received from and/or sent to other devices and/or services, such as text or other media to be displayed or otherwise played back to a user, data to support on-line or multi-player gaming, and so forth.

Navigation module 108 determines one or more routes to one or more destinations from a particular starting point within a game or other virtual world. The one or more routes are provided to output module 104 and/or additional gameplay modules 110 to display or otherwise present an indication of the one or more routes, as discussed in more detail below. Navigation module 108 can optionally determine the one or more routes in response to a user request for a route, which can be any of a variety of user inputs as discussed above with reference to input module 102.

Additional gameplay modules 110 provide various additional functionality for the game and/or other programs running on system 100. The particular functionality provided by additional gameplay modules 110 varies based on the particular game and/or program. For example, modules 110 may provide functionality to support a racing game (e.g., car racing, boat racing, spaceship racing, etc.), an adventure game allowing a user to roam around a virtual world, a combat game, a strategy game, and so forth.

Modules 102-110 can be implemented in any number of devices, such as a single device, multiple devices coupled to and communicating with one another over the Internet or other network, and so forth. For example, one device may generate data indication outputs to be generated for display or other presentation at that one device. By way of another example, one device (e.g., a server or service) can include one or more modules that generate data indicating outputs to be generated for display or other presentation to the user of a particular device, and this data can be provided to the particular device for display or other presentation to the user. Thus, a game can be implemented on a single device or across multiple devices.

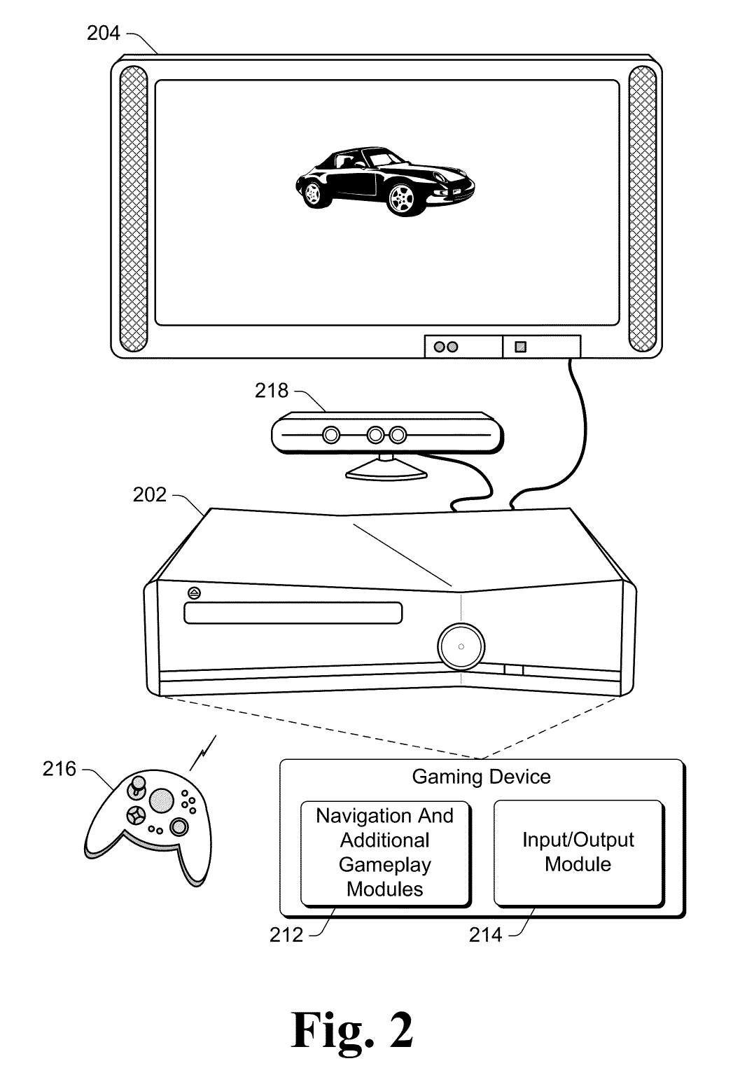

FIG. 2 illustrates an example gaming device and display in additional detail in accordance with one or more embodiments. FIG. 2 illustrates a gaming device 202, which can be or implement a system 100 of FIG. 1, coupled to a display device 204 (e.g., a television). Gaming device 202 and display device 204 can communicate via a wired and/or wireless connection. Gaming device 202 includes navigation and additional gameplay modules 212 and an input/output (I/O) module 214. Navigation and additional gameplay modules 212 can be navigation module 108 and additional gameplay modules 110 of FIG. 1.

Input/output module 214 provides functionality relating to recognition of inputs and/or provision of (e.g., display or other presentation of) outputs by gaming device 202. For example, input/output module 214 can be configured to receive inputs from a keyboard or mouse, to identify gestures and cause operations to be performed that correspond to the gestures, and so forth. The inputs can be detected by input/output module 214 in a variety of different ways. Input/output module 214 can be input module 102 and output module 104 of FIG. 1.

Input/output module 214 can be configured to receive one or more user inputs via interaction with a hardware device, such as a controller 216 as illustrated. A variety of other hardware devices are also contemplated that involve touch interaction with the device. Examples of such hardware devices include a cursor control device (e.g., a mouse), a remote control (e.g., a television remote control), a mobile communication device (e.g., a wireless phone configured to control one or more operations of gaming device 202), and other devices that involve touch on the part of a user or object.

Input/output module 214 can also be configured to receive one or more user inputs in other manners that do not involve touch or physical contact, as discussed above. For example, input/output module 214 can be configured to receive voice or other audio inputs through use of a microphone (e.g., included as part of or coupled to gaming device 202, or included as part of or coupled to camera 218). By way of another example, input/output module 214 can be configured to recognize gestures, presented objects, images, and so forth through the use of a camera 218. The images can also be leveraged by gaming device 202 to provide a variety of other functionality, such as techniques to identify particular users (e.g., through facial recognition), objects, and so on.

Gaming device 202 can also leverage camera 218 to perform skeletal mapping along with feature extraction of particular points of a human body (e.g., 48 skeletal points) to track one or more users (e.g., four users simultaneously) to perform motion analysis. For instance, camera 218 can capture images that are analyzed by input/output module 214 or a game running on gaming device 202 to recognize one or more motions made by a user, including what body part is used to make the motion as well as which user made the motion. The motions can be identified as gestures by input/output module 214 or the running game to initiate a corresponding operation.

Returning to FIG. 1, virtual world system 100 provides a virtual world in which a user can immerse himself or herself. The user being immersed in the virtual world refers to a display being presented (and optionally other data, such as audio data, played back) to make it appear as if the user is actually in and looking at the virtual world. The user is presented with the sights, sounds, and so forth of the virtual world, making it appear as if the user is actually in and interacting with the virtual world. This virtual world is typically referred to as a game, but can alternatively be other types of programs such as a reference or teaching program (e.g., a virtual world of a city, building, country, etc.). Although discussed herein with reference to games, the virtual world can alternatively be any of a variety of other types of programs.

Within the virtual world, the user has freedom to navigate, having a choice of directions that he or she can move in order to get to a particular destination (typically one or more of multiple destinations from which the user can choose). The user may have complete freedom of choice in direction (e.g., able to move in any 2-dimensional and/or 3-dimensional direction), or may be limited in choice of direction (e.g., limited to north, south, east, or west). The user may also be limited in choice of direction at any particular time due to his or her surroundings in the virtual world (e.g., the user may be able to travel only on roads, over particular types of terrain, and so forth). Regardless of how many choices in direction the user may have at any particular time, the user still has freedom to make choices as to the direction he or she moves.

In one or more embodiments, the game is played in a first-person point of view, in which the screen displays the virtual world to the user as the user would see the virtual world if the user were actually in the virtual world. Alternatively, the user may be represented by an object (also referred to as an avatar) in the virtual world. A user can optionally have multiple objects that represent the user, and can select one or more of the multiple objects when playing a particular event of a game. This object can be, for example, a vehicle (e.g., a car, boat, tank, motorcycle, spaceship, etc.), a character (e.g., a human, alien, monster, etc.), an orb or other symbol, and so forth. A user can optionally customize the object that represents the user in various manners. The customization of the object typically alters the appearance of the object (e.g., the color or pattern of vehicle paint, particular tires on a vehicle, particular facial features such as a beard or eyeglasses on a character), although various features or capabilities of the object can also be altered by the customization (e.g., performance of a vehicle or character can be altered, weaponry or defensive characteristics of a vehicle or character can be altered, etc.).

Virtual world system 100 supports a gameplay mode in which the user interacts with the virtual world of system 100. This interaction can include various different functionality based on the particular game, such as travelling in a car or other vehicle throughout the virtual world, walking or flying around the virtual world, interacting with other users (e.g., racing against other users, fighting against other users, working with other users to achieve a goal) also playing the game (e.g., in an online or multi-player game), interacting with characters controlled by the game (e.g., racing against a vehicle controlled by the game, fighting against a character controlled by the game, working with characters controlled by the game to achieve a goal), and so forth.

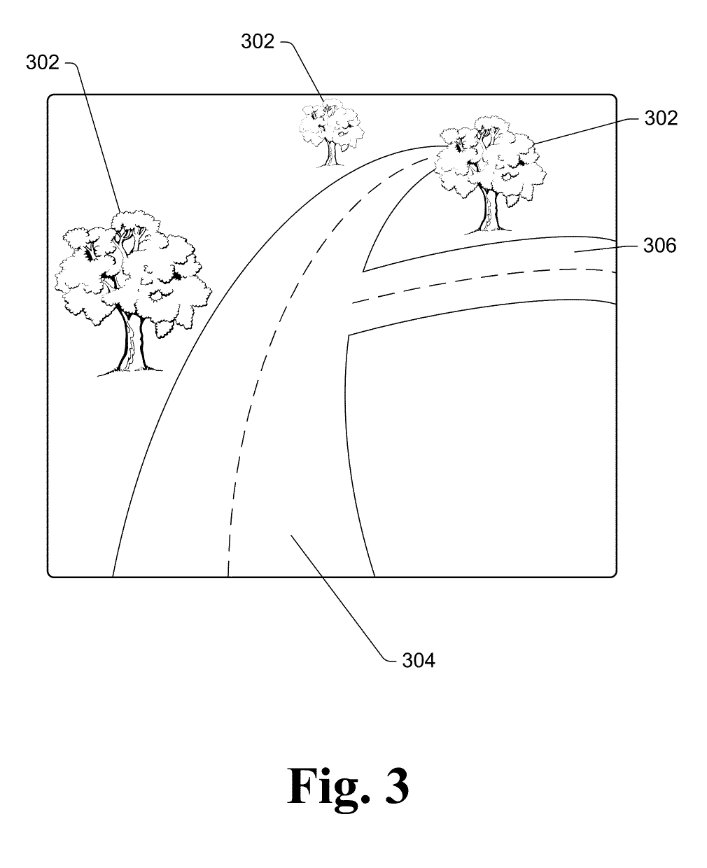

FIG. 3 illustrates an example of a gameplay mode for a virtual world in accordance with one or more embodiments. The virtual world illustrated in FIG. 3 is part of a racing game, illustrating trees 302, roads 304 and 306, and so forth. The user has a first person point of view, making it appear to the user that he or she is driving a vehicle on road 304. As illustrated, the user has the choice to continue driving straight ahead along road 304, or turn right and drive along road 306. FIG. 3 illustrates a gameplay mode with a first-person point of view. Alternatively, one or more objects representing the user can be displayed in the gameplay mode (e.g., one or more vehicles on road 304).

Returning to FIG. 1, virtual world system 100 also optionally supports a map mode in which a map of at least a portion of the virtual world is displayed to the user. The map mode is independent of the gameplay mode, which refers to the map mode being displayed as a separate screen that identifies the layout of at least part of the virtual world but is not a first-person point of view of the virtual world of system 100. For example, the user can see a map of roads and/or destinations in the virtual world in the map mode, but is not presented with a display that immerses the user in the virtual world (e.g., does not appear as if the user is driving down the road).

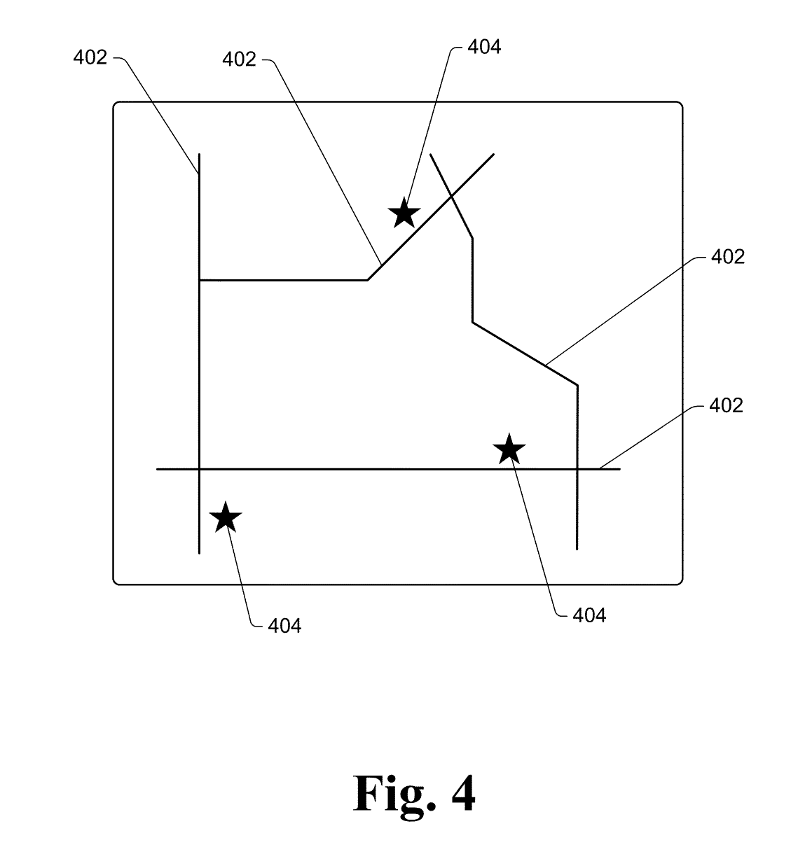

FIG. 4 illustrates an example of a map mode for a virtual world in accordance with one or more embodiments. The virtual world illustrated in FIG. 4 is part of the same racing game as the gameplay mode illustrated in FIG. 3. The user has a top-down view of the virtual world, showing roads 402, destinations 404 (illustrated as stars), and so forth.

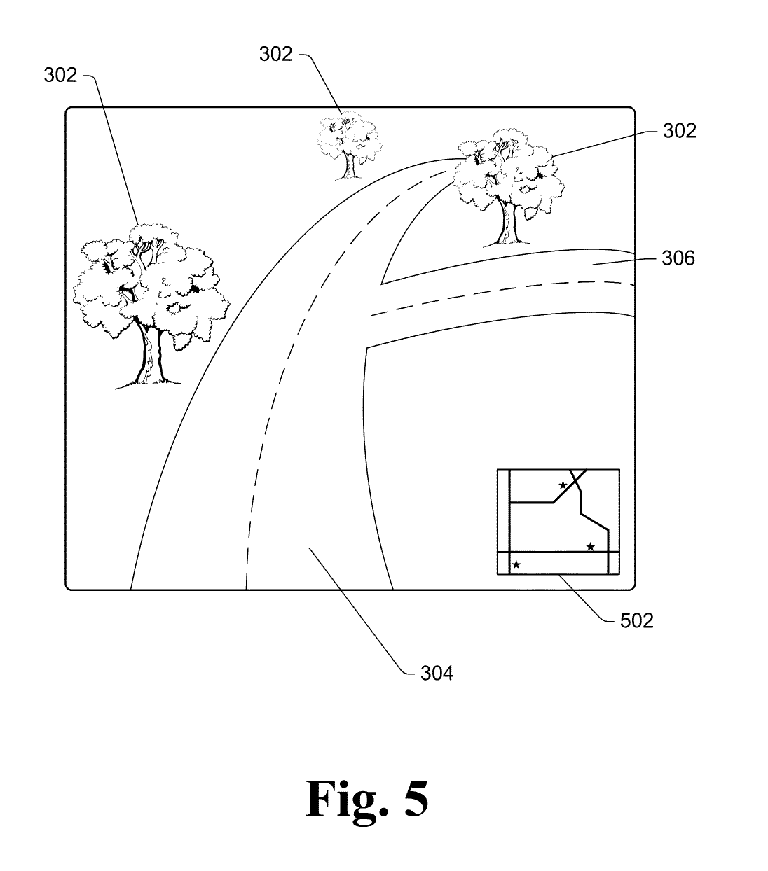

Although the map is illustrated as a separate screen in FIG. 4, alternatively a map may be displayed along with the gameplay mode. FIG. 5 illustrates an example of a gameplay mode for a virtual world in accordance with one or more embodiments. The gameplay mode displays a virtual world analogous to FIG. 3, making it appear to the user that he or she is driving a vehicle on road. A map 502 is also displayed in a corner of the screen, optionally showing a user where he or she is located. However, map 502 is still independent of the gameplay mode. The user is not immersed in the virtual world when viewing the map because the user takes his or her attention away from the virtual world in order to look at the map.

Returning to FIG. 1, virtual world system 100 allows a user to provide a user input requesting a route that satisfies particular criteria. The particular criteria can be a particular one or more destination locations (also referred to as simply destinations). Navigation module 108 determines a route from a starting location (typically the current location of the user in the virtual world) that satisfies the criteria, and an indication of this route is displayed to the user by output module 104 while in gameplay mode. Thus, the user is presented, in gameplay mode, with a path to follow along a route (e.g., to his or her desired location) and need not break his or her focus on or immersion in the virtual world in order to consult a map to determine the path to take to follow the route.

A destination can be provided by various different user inputs as discussed above. In one or more embodiments, the user input is a voice input provided by the user while in gameplay mode. For example, as the user is driving his or her vehicle along a road and is immersed in the virtual world, he or she can provide a voice input that is a request for a route to a particular destination. Input module 102 receives the request and provides the request to navigation module 108 to determine a route to the particular destination. Thus, the user need not leave the gameplay mode nor immersion in the virtual world to input the request for a route to the particular destination.

Alternatively, the user input can take other forms and/or be made through the map mode. In one or more embodiments, the user can input the request for a route to a particular destination via various user inputs as discussed above (e.g., voice, controller, touchpad or touchscreen, etc.) while in the map mode. When the user returns to gameplay mode, however, an indication of the determined route is displayed to the user while in gameplay mode. Thus, although the user may have left gameplay mode to request a route to the particular destination, he or she can return to gameplay mode and remain immersed in the virtual world while following the route without having to memorize the route.

A destination desired by the user can be identified in various different manners. When in map mode, the destination can be identified on the map, such as by clicking on or otherwise selecting a particular destination 404 in FIG. 4. The destination can also be identified in other manners, such as selection from a drop down menu, tabbing or rotating through destination options, and so forth.

In one or more embodiments, a destination desired by the user is identified by voice or other audible input by the user (whether in gameplay mode or other mode). The voice input can include two parts: one part identifying the voice input as a request for a route, and the other part identifying the desired destination. Alternatively, the voice input may only identify the desired destination (e.g., voice inputs may be assumed to be requests for a route to a destination, an indication that the voice input is a request for a route to a destination may be provided in other manners such as by pressing one or more keys on a controller, etc.).

The desired destination can be identified specifically, such as voice input naming a particular race track in a car racing game, voice input naming a particular town or landmark in an adventure game, voice input identifying a particular street address, and so forth. Additionally or alternatively the desired destination can be identified by category or type of destination, such as voice input identifying a type of race track or event, voice input identifying a type of business, and so forth. Various other criteria can optionally be provided, such as voice input identifying a type of race track and/or a race with at least a particular dollar (or other in-game currency or credit) payout, voice input identifying a type of business and/or particular product or equipment sold by the business, and so forth.

In response to a voice input identifying a category or type of destination and/or other criteria, navigation module 108 identifies a destination of the identified category or type and/or that satisfies any other criteria provided. If multiple destinations exist in the virtual world of the identified category or type and/or that satisfies any other criteria provided, navigation module 108 can select one of the multiple destinations (or alternatively display or otherwise present an indication of the multiple destinations and allow the user to provide an input selecting one of the multiple destinations or provide further criteria for choosing one of the multiple destinations (e.g., provide an input indicating to select the race that pays the most or select the easiest battle)). Navigation module 108 can select one of the multiple destinations in a variety of different manners, such as based on distance (e.g., selecting the closest destination to a current location of the user in the virtual world), based on travel time (e.g., selecting the destination having the shortest expected travel time to reach from the current location of the user in the virtual world), based on whether the user has been to the destination before (e.g., selecting a destination that the user has not been to before in the virtual world, or selecting a destination that the user visits most frequently in the virtual world), randomly, and so forth.

Various different criteria can be identified by the user. For example, the criteria may be to identify the next destination of a particular type in a series or sequence of destinations of that type, to identify a closest (to the current location of the user in the virtual world) destination of a particular type, to identify a destination having a particular product or equipment available for purchase, identify a destination having a particular characteristic (e.g., a race of at least a particular length, a race with a particular reward, etc.).

For example, in a racing game if the user desires to race in a circuit race, then the routing request and destination desired by the user can be input by a voice command of “GPS next circuit race”. The “GPS” part of the voice command indicates to virtual world system 100 that the user input is a request for a route to a particular destination, and the destination is identified as “next circuit race”. In response, navigation module 108 identifies as the destination the next circuit race that the user has not completed.

By way of another example, in a racing game if the user desires to race in a race that pays out $50,000 or more for winning the race, then the routing request and destination desired by the user can be input by a voice command of “Compass race 50,000 dollars”. The “compass” part of the voice command indicates to virtual world system 100 that the user input is a request for a route to a particular destination, and the destination is identified as “race 50,000 dollars”. In response, navigation module 108 identifies as the destination a race (e.g., the race nearest to the current location of the user in the virtual world) that pays out at least $50,000 for winning the race.

By way of yet another example, in a fantasy adventure game if the user desires to purchase a magic sword, then the routing request and destination desired by the user can be input by a voice command of “Compass magic sword available”. The “compass” part of the voice command indicates to virtual world system 100 that the user input is a request for a route to a particular destination, and the destination is identified as “magic sword available”. In response, navigation module 108 identifies as the destination a business (e.g., the business nearest to the current location of the user in the virtual world) that has a magic sword available for purchase.

Furthermore, it should be noted that the voice input can include any number of parts. Thus, the user can provide a voice input in a format other than the two-part format of the request for a route and identification of the desired destination. In one or more embodiments, the voice input can include a single statement of the goal or need of the user. For example, the user can input a voice command of “I need money”. In response, navigation module 108 identifies as the destination an ATM, a location where a job is available, a location of a bank that can be robbed, and so forth. By way of another example, the user can input a voice command of “I'm hurt”. In response, navigation module 108 identifies as the destination a hospital, a location of healing supplies, and so forth.

The criteria identified by a user can also specify a multi-point or multi-destination route. For example, the user can identify a route by identifying multiple points or destinations along the route, such as by indicating to first go to a point A, then to a point B, then to a point C, and finally to a point D. In response, navigation module 108 identifies a route that takes the user through the multiple points or destinations in the order indicated by the user. By way of another example, the user can identify a route by identifying multiple points or destinations along the route without indicated a desired order (e.g., indicating to point A, point B, and point C). In response, navigation module 108 identifies a route that takes the user through the multiple points or destinations. The order that the route takes through the multiple points or destinations can be identified in different manners, such as randomly, a shortest or fastest route, a most efficient route, and so forth. By way of yet another example, the user can identify multiple points or destinations of a route more generically, such as providing a voice command of “First go to the bank, then to the grocery store”. In response, navigation module 108 identifies a route that takes the user to a bank and then a grocery store. For each of multiple such destinations along a multi-destination route, if multiple destinations exist in the virtual world that satisfy the criteria (e.g., multiple “bank” destinations, multiple “grocery store” destinations, etc.), one of the multiple destinations can be selected in various manners as discussed above.

Although the criteria identified by the user can be one or more destinations as discussed above, alternatively the criteria identified by the user (e.g., as a voice input) can describe or otherwise identify a desired route that need not have a particular destination. For example, the user can input a voice command of “I want to drive in the mountains for 20 minutes”. In response, navigation module 108 identifies a route that is approximately 20 minutes in duration and drives through the mountains. By way of another example, the user can input a voice command of “I want to drive fast”. In response, navigation module 108 identifies a route on highways or other roads on which the user can travel at a high rate of speed.

The specific destinations, types of destinations, and/or other criteria input by the user in identifying destinations can vary based on the particular virtual world and desires of the designer of the virtual world. For example, any of a variety of different events, landmarks, businesses, characters, and so forth can be identified as a destination.

In one or more embodiments, an indication of one or more destinations is presented by output module 104. The indication can be presented in different manners, such as played back audibly to the user, displayed on a portion of the screen, and so forth. The indication of the destination can be a name of the destination (e.g., the name of a race track, the name of a business, etc.) and/or other information identifying the destination. Various additional information can also be displayed regarding the destination, such as a distance to the destination, an expected travel time to get to the destination, a cost of an item (e.g., identified in the routing request) at the destination, a payout or reward (e.g., a payout amount for winning a race) at the destination, and so forth. For example, in response to the voice command of “GPS next circuit race”, navigation module 108 identifies as the destination the next race in the circuit that the user has not completed, and output module 104 plays back audibly (or otherwise presents) the name of the next race. In situations in which the route is a multi-destination route, an indication of all the destinations in the route can be presented by output module 104, or alternatively an indication of only particular destinations in the route (e.g., the next destination along the route) can be presented by output module 104.

Given the desired one or more destinations (which may be a selected one or more of multiple destinations) and/or other user identified criteria, as well as a current location of the user in the virtual world, navigation module 108 can obtain a route that satisfies the user identified criteria (e.g., a route to the one or more destination). Navigation module 108 and/or an additional gameplay module 110 can use various conventional search techniques and/or pre-determined information regarding the virtual world to readily determine the route given the current location, destination and/or other criteria, and known layout of the virtual world. The manner in which the route is determined can vary based on the particular virtual world, taking into account various aspects of the virtual world (e.g., valid directions for navigation, roads or other terrain over which travel is permitted or not permitted, etc.).

Given the determined route, output module 104 displays an indication of the route in gameplay mode. The indication of the route can take various forms, such as a line, an arrow, flags, dust or clouds, shadows, and so forth. The particular indication can vary for different games based on the nature of the particular game and the desires of the game designer. For example, for a car racing game the indication may be a line or arrow on the road, and for a fantasy adventure game the indication may be a line or path of fairy dust.

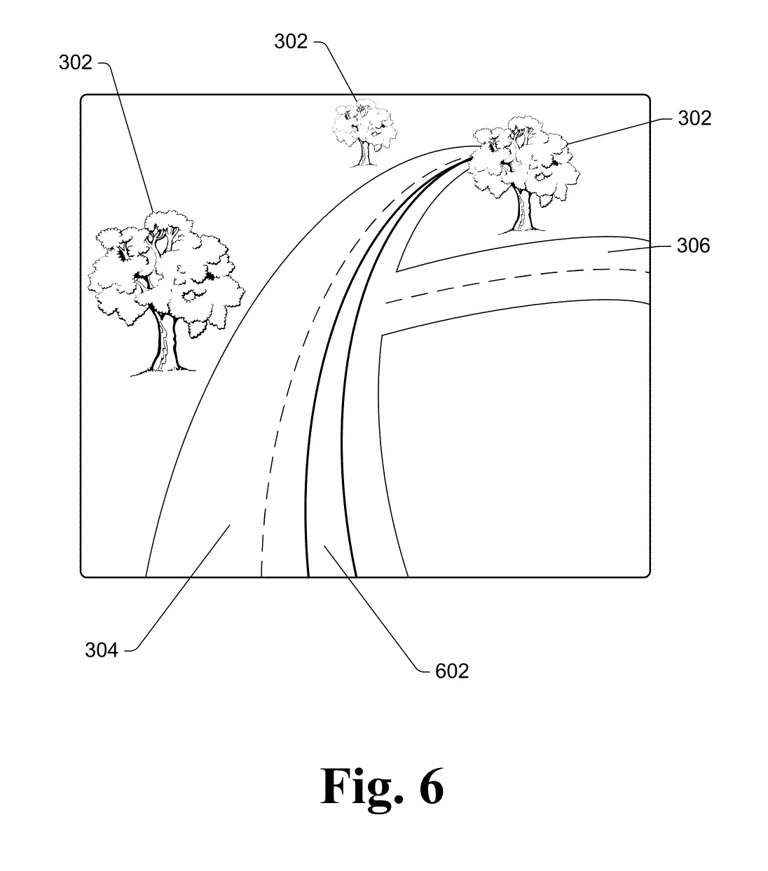

FIG. 6 illustrates an example of a gameplay mode with a route indication in accordance with one or more embodiments. The virtual world illustrated in FIG. 6 is the same as illustrated in FIG. 3, but includes an indication 602 of the route. In the illustrated example of FIG. 6, the indication 602 is a path (e.g., a line of a particular width) on the road in front of the user. Thus, the user can readily see while in gameplay mode that in order to reach his or her desired destination or follow the route otherwise determined based on his or her criteria, it is recommended that he or she remain going straight ahead on road 304 rather than turning onto road 306.

Returning to FIG. 1, the indication of the route is dynamic, being updated (e.g., by navigation module 108) as appropriate based on changes in the current location of the user. If the user follows the route, then the route remains the same and the indication is updated to reflect a current location along the path based on the current location of the user in the virtual world. However, if the user strays from the route, such as by turning onto a road that is not along the route or otherwise moving in a direction contrary to the route, then the route is updated. Updating the route refers to generating (e.g., by navigation module 108) a new route from the new current location that satisfies the user identified criteria. This new route may include various different turns or movements, including possibly to return the user to the previous route, to have the user turn around (e.g., make a U-turn), and so forth. Thus, if the user strays from the previously provided route, an updated route is displayed to the user allowing him or her to readily see the path to his or her destination (or follow the route otherwise determined based on his or her criteria) from his or her new current location (after straying from the previously provided route) while remaining immersed in the virtual world (and without having to switch to a map mode).

The indication of the route displayed to the user in gameplay mode can be a multi-purpose indication, providing additional game information to the user as he or she plays the game. Any additional information desired by the game designer (or optionally by the user based on configuration settings) can be provided via the indication of the route. For example, in a racing game the indication can be an arrow or line identifying recommended positioning heading into, through, and out of a curve for the user to follow (e.g., to allow the user to navigate through the curve quickly). By way of another example, in a racing game the indication can be an arrow or line that is color-coded to indicate where it is recommended that the user accelerate (e.g., green arrow or line), slow down (e.g., yellow arrow or line), or brake heavily (e.g., red arrow or line). By way of yet another example, in a fantasy adventure game the indication can be a path of dust that is color-coded to indicate where the user is protected by a charm or enchantment (e.g., a blue path of dust) or is vulnerable to attack (e.g., a red or yellow path of dust).

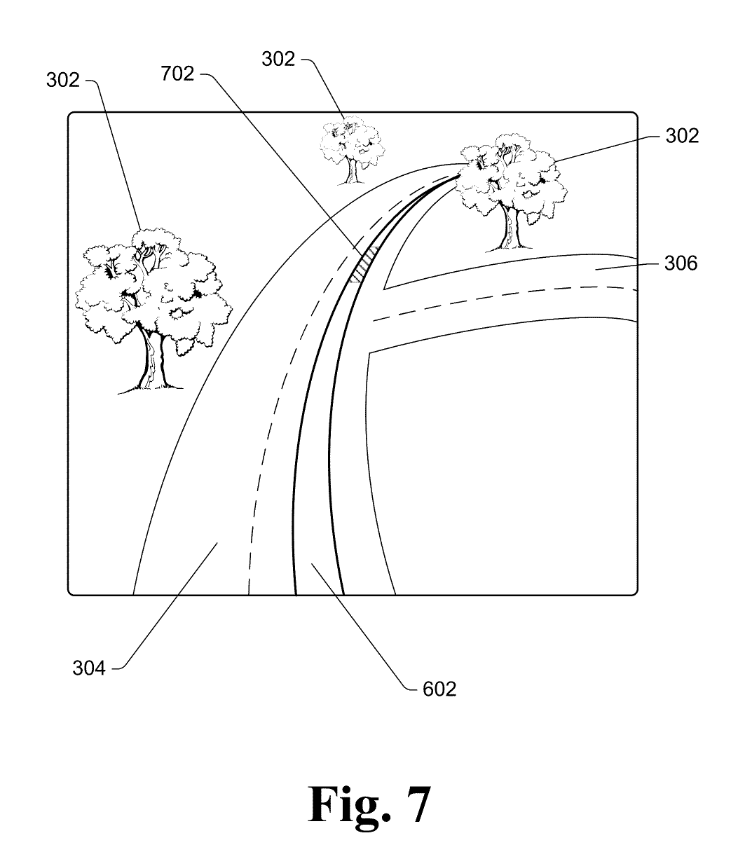

FIG. 7 illustrates an example of a gameplay mode with a route indication in accordance with one or more embodiments. The virtual world illustrated in FIG. 7 is the same as illustrated in FIG. 6, but includes an indication 702 of the route that is color-coded to indicate where it is recommended that the user accelerate or brake heavily. In the illustrated example of FIG. 7, the indication 702 is a path on the road in front of the user that is shaded (illustrated with cross-hatching) to indicate a recommendation that the user brake heavily (e.g., the shaded areas of indication 702 may be displayed in red to the user), and is non-shaded (illustrated without cross-hatching) to indicate a recommendation that the user accelerate (e.g., the non-shaded areas of indication 702 may be displayed in green to the user). Thus, not only can the user readily see while in gameplay mode that in order to reach his or her desired destination or follow the route otherwise determined based on his or her criteria it is recommended that he or she remain going straight ahead on road 304 rather than turning onto road 306, but can also readily see where it is recommended that he or she slow down or accelerate.

Returning to FIG. 1, in one or more embodiments navigation module 108 can determine multiple routes that satisfy the user identified criteria (e.g., multiple routes to the same destination) and display those multiple routes concurrently. Navigation module 108 identifies one route as a primary route (e.g., the route that is the shortest distance from the current location to the destination, the route that is the shortest travel time from the current location to the destination, and so forth). Other routes are secondary routes, and in one or more embodiments are displayed differently than the primary route. The primary route can be displayed more predominantly in order to draw attention to the primary route rather than the secondary routes. For example, the primary route may be an arrow or path larger in size and/or bolder in color, and each secondary route may be an arrow or path smaller in size and/or fainter in color (e.g., more shaded or transparent). Different secondary routes can be displayed in the same manner, or alternatively different manners. For example, navigation module 108 may rank routes based on particular criteria (e.g., the distance from the current location to the destination, the travel time from the current location to the destination, etc.), and have arrows or paths of decreasing size, decreasing boldness (e.g., shading or transparency) based on the criteria (e.g., smaller arrows or paths having larger distances and/or travel times from the current location to the destination than larger arrows or paths, more transparent arrows or paths having larger distances and/or travel times from the current location to the destination than less transparent arrows or paths, etc.).

Alternatively, rather than displaying the primary route more predominantly, the primary and secondary routes can be displayed differently in other manners. For example, particular text or other data can be included in the indications of the primary route and the secondary routes, such as an identification of an amount of money received by following the indicated route, an identification of an amount of time it will take to reach a destination along the indicated route, and so forth. By way of another example, the indications of the primary and secondary routes can be different colors, different patterns, and so forth.

The primary route, as well as each of one or more of the secondary routes, can be a multi-purpose indication as discussed above. For example, if the indications are color-coded to indicate where it is recommended that the user accelerate or brake heavily, the user can readily see that if he or she follows a secondary route whether it is recommended that he or she accelerate or brake heavily.

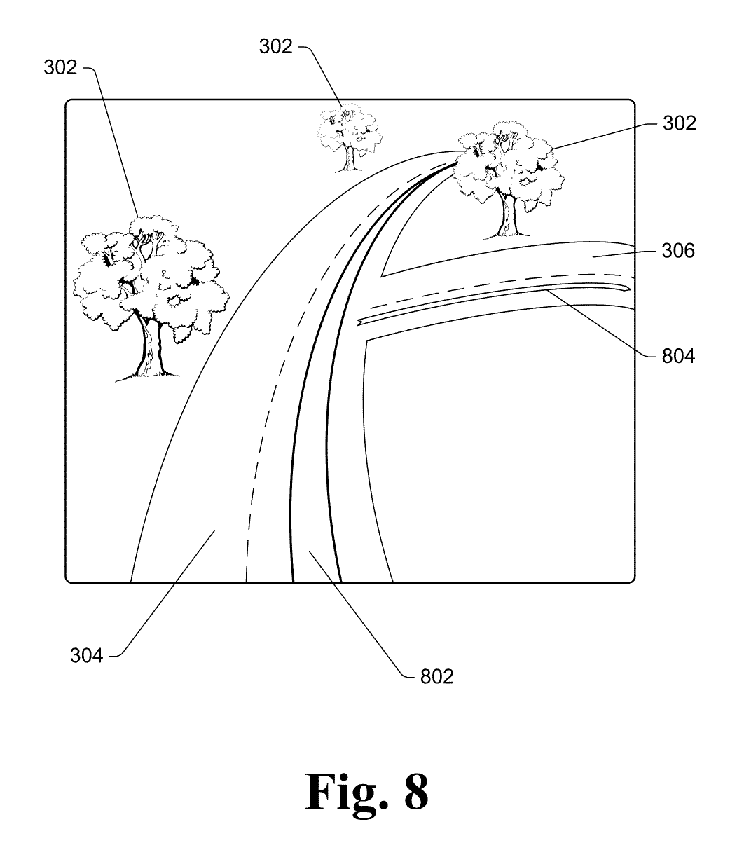

FIG. 8 illustrates an example of a gameplay mode with a route indication in accordance with one or more embodiments. The virtual world illustrated in FIG. 8 is the same as illustrated in FIG. 3, but includes an indication 802 of a primary route and an indication 804 of a secondary route. As illustrated, indication 804 is a smaller path than indication 802. Thus, the user can readily see while in gameplay mode that in order to reach his or her desired destination or follow the route otherwise determined based on his or her criteria he or she can remain going straight ahead on road 304, or can turn onto road 306 to take an alternate route. If the user were to turn on road 306, then the route along indication 804 would become the primary route, and the indication 804 may be increased in size (e.g., to a larger path).

In one or more embodiments, an indication of the route is also optionally displayed in map mode. The indication can take any of a variety of different forms, as discussed above with reference to the indication displayed in gameplay mode. The route can also be updated as discussed above, so if the user strays from a previous route, an updated route is displayed to the user if he or she returns to map mode.

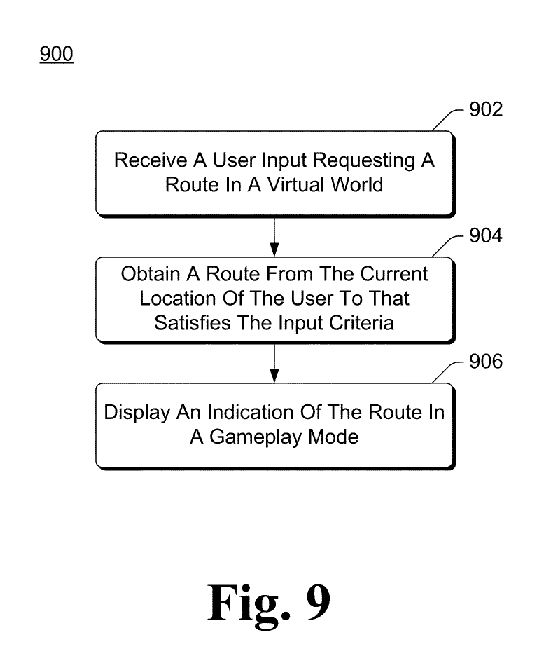

FIG. 9 is a flowchart illustrating an example process 900 for implementing the destination routing in a virtual world in accordance with one or more embodiments. Process 900 is carried out by a device or system, such as virtual world system 100 of FIG. 1 and/or gaming device 202 of FIG. 2, and can be implemented in software, firmware, hardware, or combinations thereof. Process 900 is shown as a set of acts and is not limited to the order shown for performing the operations of the various acts. Process 900 is an example process for implementing the destination routing in a virtual world; additional discussions of implementing the destination routing in a virtual world are included herein with reference to different figures.

In process 900, a user input requesting a route in a virtual world is received (act 902). The user input can be received in various manners as discussed above, such as via a voice input while in a gameplay mode (independent of a map mode), via various inputs in a map mode, and so forth. Various criteria can be identified by the user as input criteria, such as one or more destinations (e.g., identified as a specific destination, a type of destination, and/or using other criteria as discussed above) or other criteria identifying a desired route as discussed above.

A route from a current location of the user in the virtual world that satisfies the input criteria is obtained by the device (act 904). The device can determine the route itself, or alternatively a module or component of another device or service (e.g., a remote service accessed via the Internet) can determine the route and provide the route to the device.

An indication of the route is displayed in the virtual world in a gameplay mode (act 906). The indication can be displayed in various manners as discussed above, such as a line on a road, a trail of dust, and so forth. The indication can also be a multi-purpose indication, providing additional game information to the user as he or she plays the game as discussed above.

The techniques discussed herein support various different usage scenarios. The user is able to input a destination and have an indication of a route to that destination displayed to him or her in the virtual world environment he or she is immersed. The user need not pause the game and go to a map screen to see the route, need not take his or her focus away from the virtual world in order to look at a small map in the corner of the screen, and so forth. Furthermore, the user is similarly able to input the destination while immersed in the virtual world (e.g., the user can input a voice command, while immersed in the virtual world, to request a route to a destination). The user need not pause the game and go to a map screen or other destination input screen in order to input the destination.

Various actions such as communicating, receiving, sending, generating, obtaining, and so forth performed by various modules are discussed herein. A particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

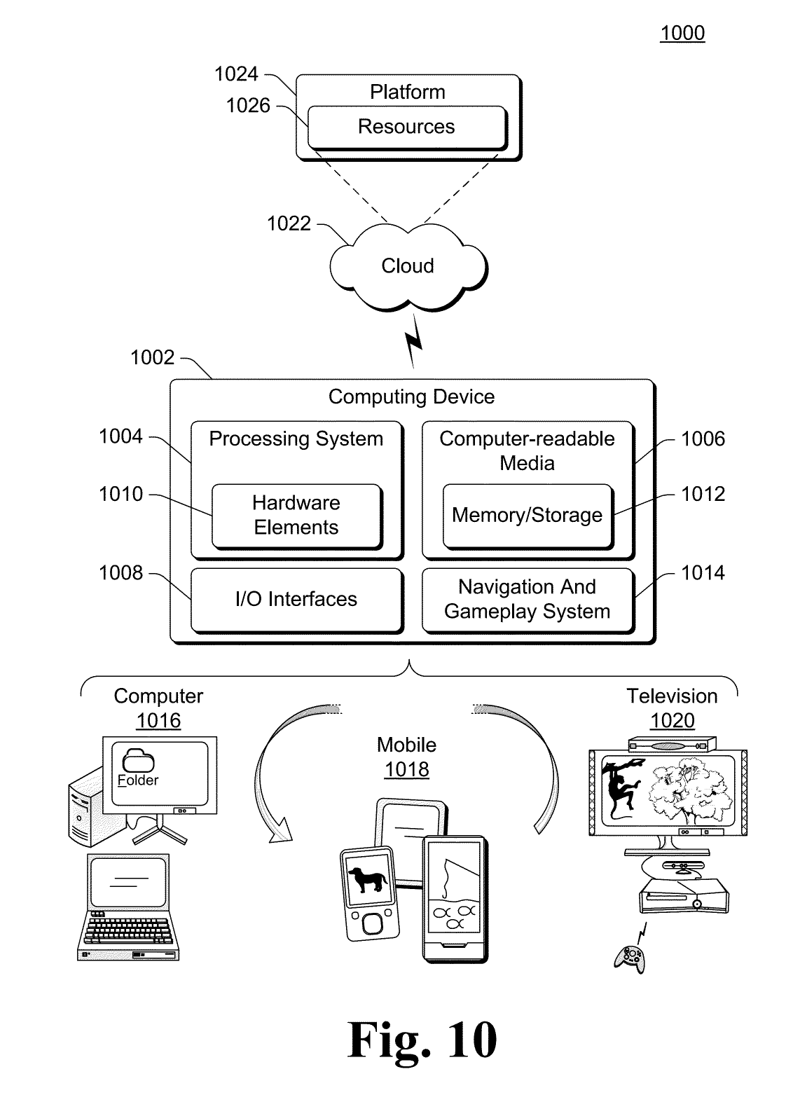

FIG. 10 illustrates an example system generally at 1000 that includes an example computing device 1002 that is representative of one or more systems and/or devices that may implement the various techniques described herein. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O Interfaces 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware elements 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including memory/storage 1012. The memory/storage 1012 represents memory/storage capacity associated with one or more computer-readable media. The memory/storage 1012 may include volatile media (such as random access memory (RAM)) and/or nonvolatile media (such as read only memory (ROM), Flash memory, optical disks, magnetic disks, and so forth). The memory/storage 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Computing device 1002 also includes a navigation and gameplay system 1014. Navigation and gameplay system 1014 provides various gameplay functionality, including navigation functionality for destination routing, as discussed above. Navigation and gameplay system 1014 can implement, for example, virtual world system 100 of FIG. 1, and/or navigation and additional gameplay modules 212 (and optionally input/output module 214) of FIG. 2.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” refers to media and/or devices that enable persistent storage of information and/or storage that is not transitory, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of modules as a module that is executable by the computing device 1002 as software may be achieved at least partially in hardware, e.g., through use of computer-readable storage media and/or hardware elements 1010 of the processing system. The instructions and/or functions may be executable/operable by one or more articles of manufacture (for example, one or more computing devices 1002 and/or processing systems 1004) to implement techniques, modules, and examples described herein.

As further illustrated in FIG. 10, the example system 1000 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1000, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 1002 may assume a variety of different configurations, such as for computer 1016, mobile 1018, and television 1020 uses. Each of these configurations includes devices that may have generally different constructs and capabilities, and thus the computing device 1002 may be configured according to one or more of the different device classes. For instance, the computing device 1002 may be implemented as the computer 1016 class of a device that includes a personal computer, desktop computer, a multi-screen computer, laptop computer, netbook, and so on.

The computing device 1002 may also be implemented as the mobile 1018 class of device that includes mobile devices, such as a mobile phone, portable music player, portable gaming device, a tablet computer, a multi-screen computer, and so on. The computing device 1002 may also be implemented as the television 1020 class of device that includes devices having or connected to generally larger screens in casual viewing environments. These devices include televisions, set-top boxes, gaming consoles, and so on.

The techniques described herein may be supported by these various configurations of the computing device 1002 and are not limited to the specific examples of the techniques described herein. This functionality may also be implemented all or in part through use of a distributed system, such as over a “cloud” 1022 via a platform 1024 as described below.

The cloud 1022 includes and/or is representative of a platform 1024 for resources 1026. The platform 1024 abstracts underlying functionality of hardware (e.g., servers) and software resources of the cloud 1022. The resources 1026 may include applications and/or data that can be utilized while computer processing is executed on servers that are remote from the computing device 1002. Resources 1026 can also include services provided over the Internet and/or through a subscriber network, such as a cellular or Wi-Fi network.

The platform 1024 may abstract resources and functions to connect the computing device 1002 with other computing devices. The platform 1024 may also serve to abstract scaling of resources to provide a corresponding level of scale to encountered demand for the resources 1026 that are implemented via the platform 1024. Accordingly, in an interconnected device embodiment, implementation of functionality described herein may be distributed throughout the system 1000. For example, the functionality may be implemented in part on the computing device 1002 as well as via the platform 1024 that abstracts the functionality of the cloud 1022.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a device, the method comprising:
receiving a user input requesting a route that satisfies user input criteria in a virtual world;
obtaining, by the device, the route from a current location of the user in the virtual world and that satisfies the user input criteria; and
displaying, in the virtual world in a gameplay mode in which the user interacts with the virtual world, an indication of the route.

2. A method as recited in claim 1, further comprising receiving the user input and displaying the indication of the route while remaining in the gameplay mode.

3. A method as recited in claim 1, the displaying the indication comprising displaying a multi-purpose indication that provides, in addition to the indication of route, additional game information.

4. A method as recited in claim 3, the additional game information comprising an indication of where it is recommended that the user accelerate or brake in a racing game.

5. A method as recited in claim 1, the displaying comprising displaying multiple routes to a destination of the route concurrently, including displaying one of the multiple routes differently than one or more others of the multiple routes.

6. A method as recited in claim 1, further comprising updating both the route and the indication of the route in response to the user straying from the route.

7. A method as recited in claim 1, the user input criteria comprising one or more destinations.

8. A method as recited in claim 1, the user input comprising a voice command.

9. A method as recited in claim 1, the receiving the user input and the obtaining the route comprising receiving the user input and obtaining the route independent of a map for the virtual world displayed in a map mode.

10. A method as recited in claim 1, the method further comprising presenting, while in the gameplay mode, an indication of a destination of the route.

11. One or more computer storage media having stored thereon multiple instructions that, when executed by one or more processors of a device, cause the one or more processors to:
receive, independent of a map mode in which a map of a virtual world is displayed, a user request for a route that satisfies user input criteria, the route being in the virtual world;
obtain, by the device, the route that satisfies the user input criteria; and
display, independent of the map mode, an indication of the route.

12. One or more computer storage media as recited in claim 11, wherein to receive the user request and display the indication of the route is to receive the user request and display the indication of the route while remaining in a gameplay mode in which the user interacts with the virtual world.

13. One or more computer storage media as recited in claim 12, the multiple instructions further causing the one or more processors to present, while in the gameplay mode, an indication of one or more destinations in the route.

14. One or more computer storage media as recited in claim 11, the indication comprising a multi-purpose indication that provides, in addition to the indication of the route, additional game information.

15. One or more computer storage media as recited in claim 14, the additional game information comprising an indication of where it is recommended that the user accelerate or brake in a racing game.

16. One or more computer storage media as recited in claim 11, the instructions causing the one or more processors to display the indication of the route comprising instructions causing the one or more processors to display multiple routes to a destination concurrently, and to display one of the multiple routes differently than one or more others of the multiple routes.

17. One or more computer storage media as recited in claim 11, the multiple instructions further causing the one or more processors to update both the route and the indication of the route in response to the user straying from the route.

18. One or more computer storage media as recited in claim 11, wherein to obtain the route is to determine, at the device, the route.

19. One or more computer storage media as recited in claim 11, the user request comprising a voice input.

20. A method implemented in a device, the method comprising:
receiving a user input requesting a route to a destination in a virtual world, the user input comprising a voice input that identifies the destination in the virtual world;
obtaining, by the device, the route from a current location of the user in the virtual world to the destination, the destination being selected from multiple destinations based on distances from the current location to each of the multiple destinations; and
displaying, in the virtual world in a gameplay mode in which the user interacts with the virtual world, an indication of the route, the indication comprising a multi-purpose indication that also provides additional game information.
